(19) United States
(12) Patent Application Publication
(10) Pub. No.: US 2025/0343018 A1
(43) Pub. Date: Nov. 6, 2025

(54) ESCUTCHEON MODULES FOR CIRCUIT BREAKERS

(71) Applicant: Schneider Electric USA, Inc., Andover, MA (US)

(72) Inventor: Cristina Rosas Salazar, Andover, MA (US)

(73) Assignee: Schneider Electric USA, Inc., Andover, MA (US)

(21) Appl. No.: 18/653,108

(22) Filed: May 2, 2024

(51) Int. Cl. H01H 71/02; H01H 71/04; H01H 71/10; H01H 71/66; H01H 83/04

(52) U.S. Cl. CPC H01H 71/0264; H01H 71/0228; H01H 71/04; H01H 71/1009; H01H 71/66; H01H 83/04; H01H 2071/042

(57) ABSTRACT

An escutcheon module for a circuit breaker includes an escutcheon body configured to seat against a switch face of a circuit breaker. One or more attachments of the escutcheon body are configured to engage with one or more attachment points of the circuit breaker. The escutcheon body can add functionality to the circuit breaker, such as a USB connectivity, Bluetooth connectivity, or Wi-Fi connectivity. The escutcheon body can be of a color the same as or different from the color of the breaker housing. It is also contemplated that the escutcheon body can include a receptacle for a physical lock for locking a switch of the circuit breaker.

### BACKGROUND

### 1. Field

The present disclosure relates to electrical circuit protection, and more particularly to circuit breakers such as for residential applications for protecting circuits from ground faulting, overcurrent conditions, and the like.

### 2. Description of Related Art

Circuit protection, such as for protecting the electrical circuits in a residential application, is typically provided by a set of circuit breakers that connect between a main bus and the various circuits of the residence. If a ground fault or other overcurrent condition occurs in one of the circuits, the circuit breaker for that circuit trips, disconnecting the faulting circuit from the bus to prevent damage. In a residential setting, the circuit breakers can be referred to as miniature circuit breakers (MCBs), as contrasted with circuit breakers used in more industrial settings.

The conventional techniques have been considered satisfactory for their intended purpose. However, there is an ever-present need for improved systems and methods for improved functionality of circuit breakers such as MCBs. This disclosure provides a solution for this need.

### SUMMARY

An escutcheon module for a circuit breaker includes an escutcheon body configured to seat against a switch face of a circuit breaker. One or more attachments of the escutcheon body are configured to engage with one or more attachment points of the circuit breaker.

The escutcheon body can include a clearance area configured to allow a switch of the circuit breaker to be accessible and functional with the escutcheon body engaged to the circuit breaker. The escutcheon body can include a test or reset button configured to mechanically interface with a test or reset mechanism of the circuit breaker. A printed circuit board assembly (PCBA) can be assembled to the escutcheon body. The PCBA can include an electrical interface configured for connecting to circuit components of the circuit breaker with the escutcheon body engaged to the circuit breaker. The PCBA can include circuitry configured to connect an external device to interact with the circuit breaker with the escutcheon body engaged to the circuit breaker. The PCBA can include an input/output interface configured for connecting with the external device by at least one of a USB connection, a Bluetooth connection, or a Wi-Fi connection.

The escutcheon body can include a display configured to connect to circuitry of the circuit breaker to display information regarding the circuit breaker with the escutcheon module engaged to the circuit breaker. The display can include a touch screen for user interaction with the circuit breaker. The escutcheon body can include at least one receptacle for a physical lock positioned to lock a switch of the circuit breaker. The escutcheon body can be dimensioned and configured to engage a circuit breaker that is a miniature circuit breaker (MCB).

A circuit breaker system includes a circuit breaker including a breaker housing. A mechanical switch is operatively connected to an overcurrent disconnect mechanism configured to break a circuit undergoing an overvoltage state. An escutcheon connector is on an outward face of the breaker housing including attachment points configured to engage an interchangeable escutcheon module.

An escutcheon module as described above can be engaged to the escutcheon connector. The escutcheon module can be of a different color than the breaker housing. The escutcheon module can include an escutcheon body configured to seat against a switch face of a circuit breaker wherein attachments of the escutcheon body are engaged with the attachment points of the breaker housing. The escutcheon body can include a clearance area configured to allow a switch of the circuit breaker to be accessible and functional with the escutcheon body engaged to the breaker housing. The escutcheon body can include a test or reset button configured to mechanically interface with a test or reset mechanism of the mechanical switch. It is also contemplated that the escutcheon body can include a service LED.

A printed circuit board assembly (PCBA) can be assembled in the breaker housing. The PCBA can include an electrical interface operatively connected to circuit components of the escutcheon module. The PCBA can include circuitry configured to connect an external device to interact with the circuit breaker. The PCBA can include an input/output interface configured for connecting with the external device by at least one of a USB connection, a Bluetooth connection, or a Wi-Fi connection.

The escutcheon body can include a display configured to connect to circuitry of the circuit breaker to display information regarding the circuit breaker with the escutcheon module engaged to the circuit breaker. The display can include a touch screen for user interaction with the circuit breaker. The escutcheon body can include at least one receptacle for a physical lock positioned to lock the mechanical switch. The circuit breaker can be a miniature circuit breaker (MCB). The circuit breaker can be configured for at least one of single phase, single pole (1P), single phase double pole (2P), single phase three pole (3P), ground fault (GF), arc fault (AF), and/or combined ground fault and arc fault (DF) operation.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic partially cross-sectional perspective view of an embodiment of a circuit breaker system constructed in accordance with the present disclosure, showing the circuit breaker without an escutcheon module;

FIG. 2 is a schematic perspective view of an escutcheon module for use with the circuit breaker of FIG. 1;

FIG. 3 is a schematic perspective view of the system of FIGS. 1 and 2, showing the escutcheon module engaged to the circuit breaker;

FIG. 4 is a schematic perspective view of a portion of the system of FIG. 1, showing the printed circuit board assembly (PCBA);

FIG. 5 is a schematic perspective view of a portion of the system of FIG. 3, showing the PCBA pre-installed to the escutcheon module instead of to the circuit breaker;

FIGS. 6-8 are schematic front elevation views of the system of FIG. 1, showing escutcheon modules for Wi-Fi, Bluetooth, and USB connectivity, respectively;

FIG. 9 is a schematic front elevation view of the system of FIG. 1, showing an escutcheon module with a digital display;

FIG. 10 is a schematic perspective view of the system of FIG. 1, showing an escutcheon module with a lock receptacle;

FIG. 11 is a schematic perspective view of the system of FIG. 10, showing a lock engaged to lock the switch; and

FIGS. 12-16 are schematic front perspective views of systems of FIG. 1, showing different underlying breaker configurations.

### DETAILED DESCRIPTION OF THE PREFERRED EMBODIMENTS

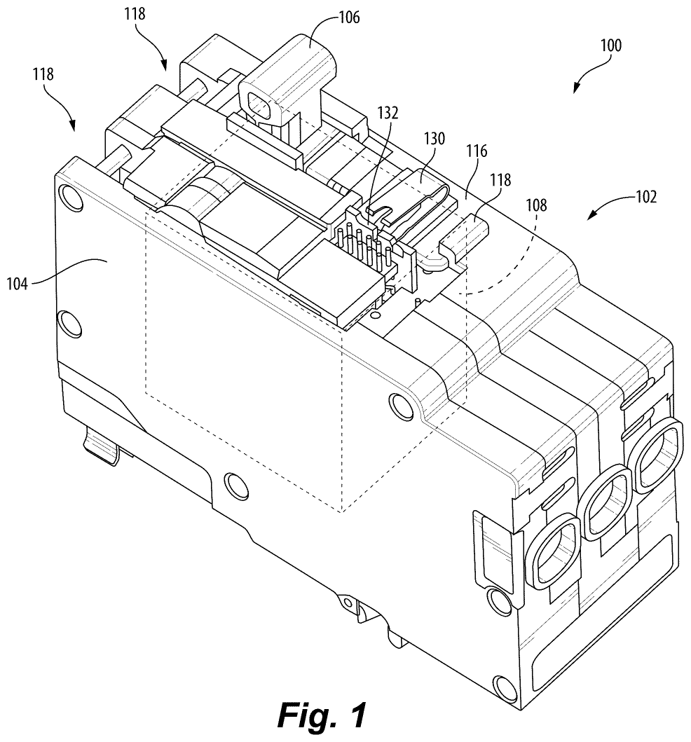

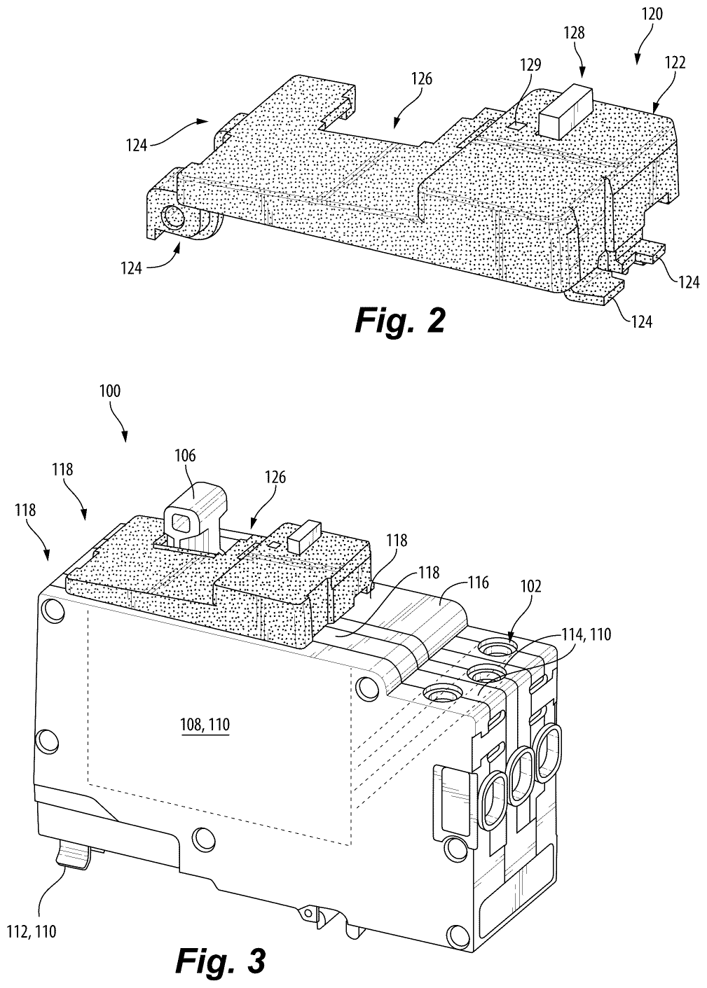

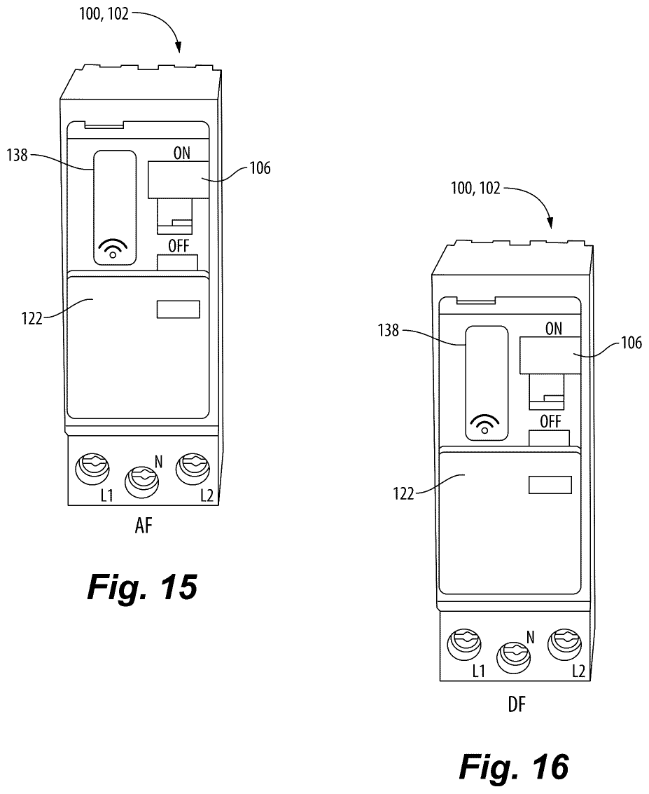

Reference will now be made to the drawings wherein like reference numerals identify similar structural features or aspects of the subject disclosure. For purposes of explanation and illustration, and not limitation, a partial view of an embodiment of a system in accordance with the disclosure is shown in FIG. 1 and is designated generally by reference character 100. Other embodiments of systems in accordance with the disclosure, or aspects thereof, are provided in FIGS. 2-16, as will be described. The systems and methods described herein can be used to enhance functionality and customization of circuit breakers such as miniature circuit breakers (MCBs) for residential use.

The circuit breaker system 100 includes a circuit breaker 102 including a breaker housing 104. A mechanical switch 106 is operatively connected to an overcurrent disconnect mechanism 108 configured to break a circuit 110 undergoing an overvoltage state, ground fault, arc fault, or the like. The circuit 110 connects the bus connectors 112 through the disconnect mechanism 108 to the wire connectors 114 of the circuit breaker 102 (as labeled in FIG. 3). An escutcheon connector is included on an outward switch face 116 of the breaker housing 104 including attachment points 118 configured to engage an interchangeable escutcheon module 120 as shown in FIGS. 2-3.

With reference now to FIG. 2, the escutcheon module 120 includes an escutcheon body 122 configured to seat against the switch face 116 of a circuit breaker 102 (as shown in FIG. 3). One or more attachments 124 of the escutcheon body 122 are engaged with the one or more attachment points 118 of the breaker housing 104 of the circuit breaker 102 of FIG. 1 to form the assembled system 100 of FIG. 3. The escutcheon body 122 includes an optional clearance area 126 configured to allow the switch 106 of the circuit breaker 102 to be accessible and functional with the escutcheon body 122 engaged to the breaker housing 104 of the circuit breaker 102. The clearance area 122 is not necessary in configurations that do not need clearance for a switch 106. The escutcheon body 122 includes a test or reset button 128 configured to mechanically interface with a test or reset mechanism, e.g., through connector 130 (labeled in FIG. 1) of the mechanical switch 106 of the circuit breaker 102. The escutcheon module 120 can be of a different color than the breaker housing 104, and multiple escutcheon modules 120 in a single circuit breaker panel can be different colors from one another, as a visual coding or organization tool for the end user. It is also contemplated that the escutcheon body can include a service LED 129, which can be used as an indicator for advanced functions of the circuit breaker 102, e.g., when a user pushes test or reset button 128, the Service LED 129 can blink different patterns, wherein each pattern means something different, as stated in an instruction bulletin.

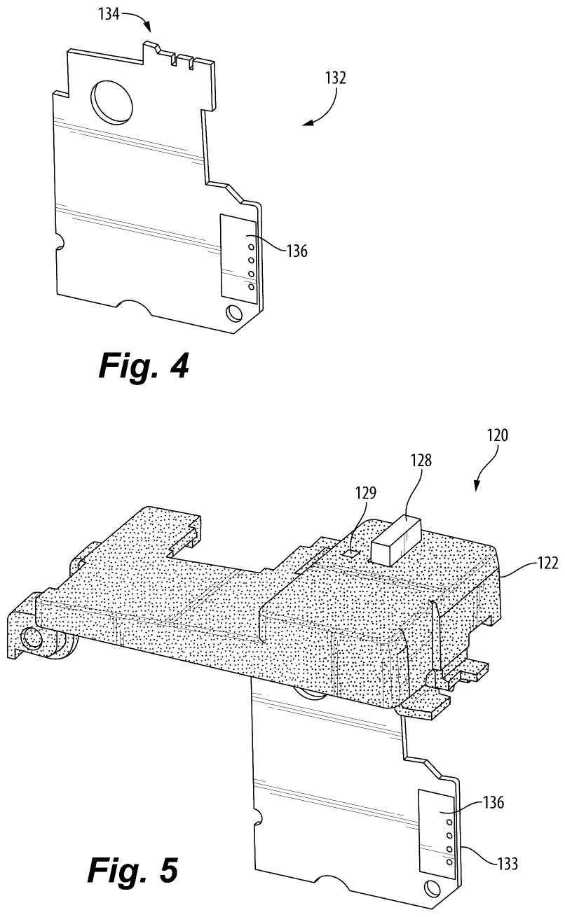

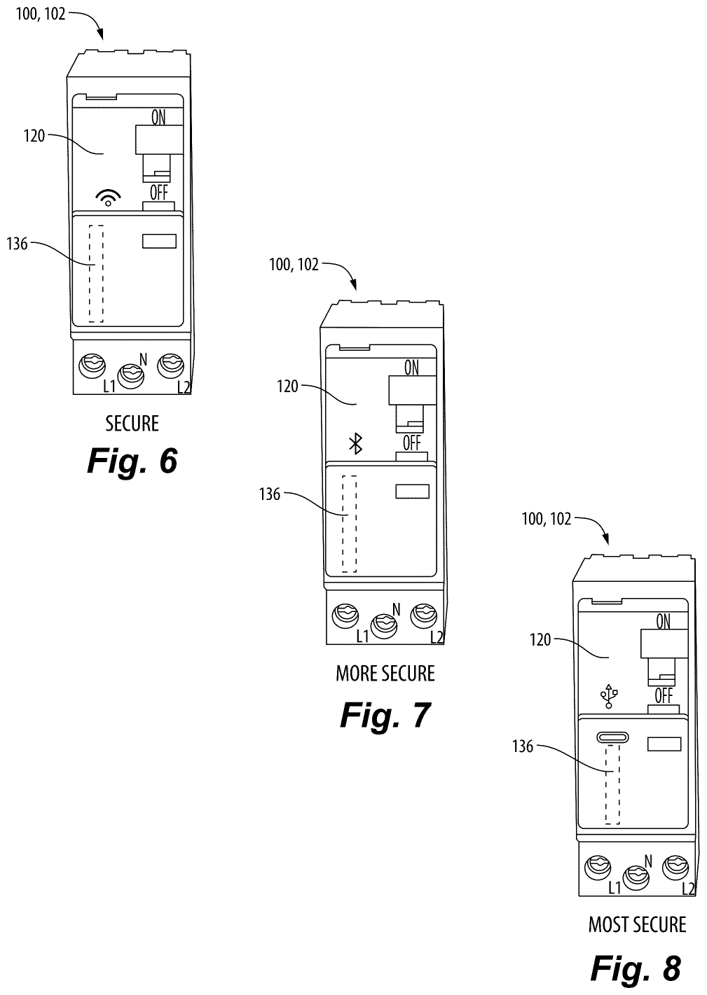

With reference now to FIG. 3, the escutcheon module 120 is engaged to the one or more attachment points 118 of the escutcheon connector. FIG. 4 shows a printed circuit board assembly (PCBA) 132 which can be assembled in the breaker housing 104 as shown in FIG. 1, wherein the PCBA 132 includes an electrical interface operatively connected to circuit components of the escutcheon module 120, e.g. via the connector 130 of the test or reset mechanism, labeled in FIG. 1. It is also contemplated that a PCBA 133 can be manufactured assembled to the escutcheon body 122, e.g. under the test or reset button 128 as shown in FIG. 5, wherein attaching the escutcheon body 122 to the circuit breaker housing 104 connects the PCBA 133 to the PCBA 132 inside the breaker housing 104, e.g. with the PCBA 133 physically parallel to the PCBA 132. The PCBA 132 and/or 133 can include an electrical interface 134 configured for connecting to circuit components of the circuit breaker 102 and escutcheon module 120 to the circuit components of the PCBA 132 with the escutcheon body 122 engaged to the circuit breaker 102. The PCBA 132 and/or 133 can include circuitry configured to connect an external device to interact with the circuit breaker. More particularly, the PCBA 132 and/or 133 can include an input/output interface 136 configured for connecting with the external device by at least one of a USB connection, a Bluetooth connection, or a Wi-Fi connection. As indicated in FIGS. 6, 7, and 8, respectively, the input/output interface can be for Wi-Fi connection, including secure Wi-Fi, can be Bluetooth connection, which can offer more security, or can be for USB connection, which can offer even more security. The input/output interface 136 can connect to an external device to output trip status of the circuit breaker 102, and can receive input from the external device, e.g., for controlling opening, closing, fault clearing, and testing the contactors of the circuit breaker 102.

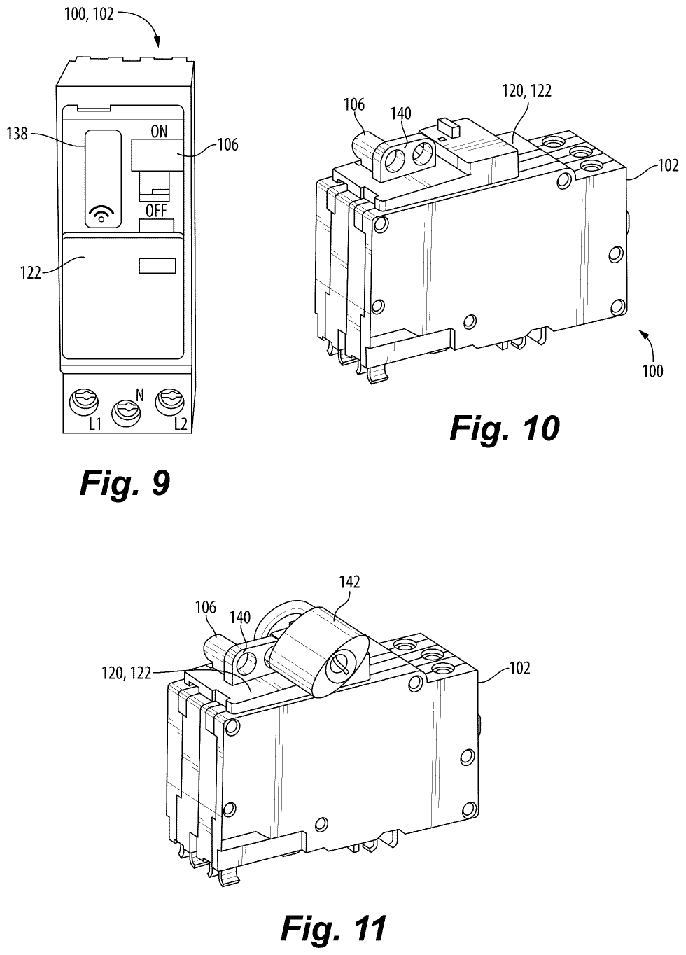

With reference now to FIG. 9, it is contemplated that in addition to or in lieu of connecting an external device as described above with reference to FIGS. 6-8, the escutcheon body 122 can include a display 138 configured to connect to circuitry of the circuit breaker 102 to display information regarding the circuit breaker 102 with the escutcheon module engaged 120 to the circuit breaker. The information displayed can include a name for the circuit protected by the circuit breaker 102, connection status of an external device (such as the Wi-Fi connected status indicated in FIG. 9), and/or trip status of the circuit breaker 102. The display 138 can include a touch screen for user interaction with the circuit breaker 102. This can allow a user to control the functions described above with respect to FIGS. 6-8, but without a need for an external device.

With reference now to FIGS. 10 and 11, the escutcheon body 122 can include at least one receptacle 140 for receiving a physical lock 142, e.g. a padlock as shown in FIG. 11, positioned to lock the mechanical switch 106, e.g. to lock the switch 106 ON, to lock the switch 106 OFF, or to lock the switch so that whether it is in the ON or OFF position, it cannot be moved to the other of the ON or OFF position without removing the lock 142.

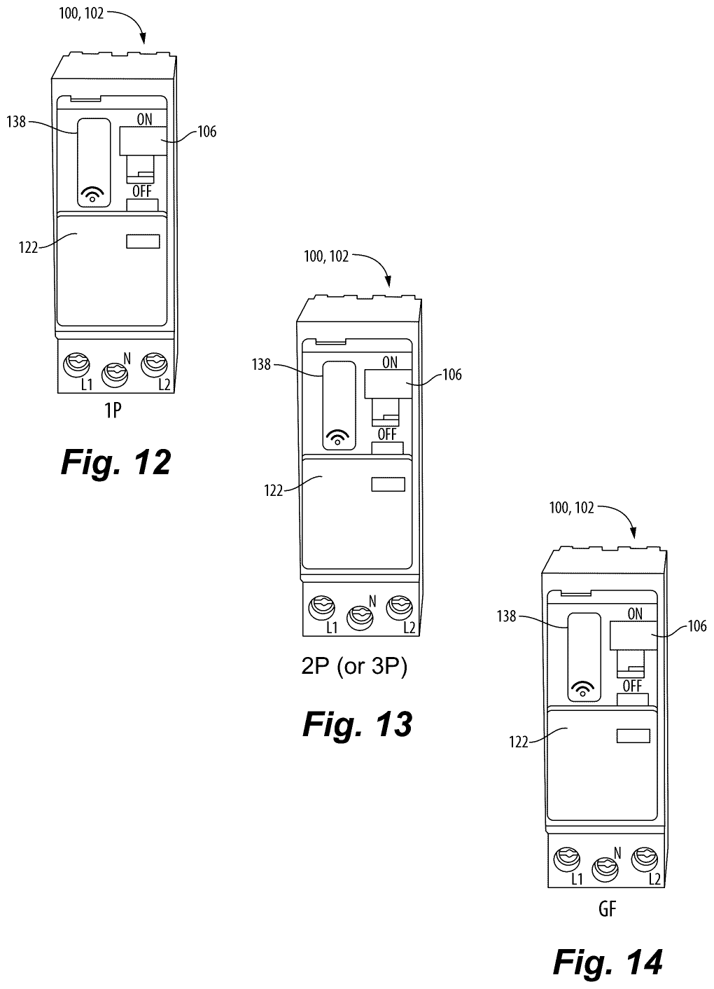

The circuit breaker 102 can be a miniature circuit breaker (MCB), e.g., for residential circuit protection. As shown in FIGS. 12-16, respectively, the circuit breaker 102 can be configured for at least one of single phase, single pole (1P), single phase double pole (2P), single phase three pole (3P), ground fault (GF), arc fault (AF), and/or combined ground fault and arc fault (DF) operation.

The present disclosure provides for modular escutcheons for advanced function miniature circuit breakers. The escutcheon modules can include a display, touch screen, embedded lockout accessories, connections to the PCBA for different types of smart connectivity or any combination of these features. It is also contemplated that various escutcheon modules can be included as a kit or set with different ones of the escutcheon modules having different combinations of the foregoing features, including one or more escutcheon modules that are plain covers for the circuit breaker without any other function. Moreover, the escutcheon modules in such a kit or set can be of various colors for visual organization of a residential breaker box. It is also contemplated that the escutcheon modules as disclosed herein can be manufactured as part of the respective circuit breakers, or the circuit breakers and escutcheon modules can be manufactured separate from one another for the end user to customize as needed by assembling escutcheon modules and circuit breakers together as needed to produce the given features needed for a given application.

Connection of external devices allows for a user to be able to view tipping history, to monitor a circuit breaker's handle position, to monitor power, to trip a breaker remotely, to view a breaker's health, and the like. If manufactured separately, the cost of manufacturing a circuit breaker would be maintained, and final price of the combined circuit breaker and escutcheon module can vary depending on the customization. The escutcheon modules disclosed herein can facilitate continuous engineering, simplifying to a single architecture main circuit breaker body.

The methods and systems of the present disclosure, as described above and shown in the drawings, provide for enhanced functionality and customization of circuit breakers such as miniature circuit breakers (MCBs) for residential use. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. An escutcheon module for a circuit breaker comprising:
an escutcheon body configured to seat against a switch face of a circuit breaker wherein one or more attachments of the escutcheon body are configured to engage with one or more attachment points of the circuit breaker.

2. The module as recited in claim 1, wherein the escutcheon body includes a clearance area configured to allow a switch of the circuit breaker to be accessible and functional with the escutcheon body engaged to the circuit breaker; and/or wherein the escutcheon body includes a test or reset button configured to mechanically interface with a test or reset mechanism of the circuit breaker.

3. The module as recited in claim 1, further comprising a printed circuit board assembly (PCBA) assembled to the escutcheon body, wherein the PCBA includes an electrical interface configured for connecting to circuit components of the circuit breaker with the escutcheon body engaged to the circuit breaker.

4. The module as recited in claim 3, wherein the PCBA includes circuitry configured to connect an external device to interact with the circuit breaker with the escutcheon body engaged to the circuit breaker, wherein the PCBA includes an input/output interface configured for connecting with the external device by at least one of:
a USB connection;
a Bluetooth connection; or a Wi-Fi connection.

5. The module as recited in claim 1, wherein the escutcheon body includes a display configured to connect to circuitry of the circuit breaker to display information regarding the circuit breaker with the escutcheon module engaged to the circuit breaker.

6. The module as recited in claim 5, wherein the display includes a touch screen for user interaction with the circuit breaker.

7. The module as recited in claim 1, wherein the escutcheon body includes at least one receptacle for a physical lock positioned to lock a switch of the circuit breaker.

8. The module as recited in claim 1, wherein the escutcheon body is dimensioned and configured to engage a circuit breaker that is a miniature circuit breaker (MCB).

9. A circuit breaker system comprising:
a circuit breaker including:
a breaker housing;
a mechanical switch operatively connected to an overcurrent disconnect mechanism configured to break a circuit undergoing an overvoltage state; and
an escutcheon connector on an outward switch face of the breaker housing including attachment points configured to engage an interchangeable escutcheon module.

10. The system as recited in claim 9, further comprising the escutcheon module engaged to the escutcheon connector.

11. The system as recited in claim 10, wherein the escutcheon module is of a different color than the breaker housing.

12. The system as recited in claim 10, wherein the escutcheon module includes an escutcheon body configured to seat against the outward switch face of a circuit breaker wherein attachments of the escutcheon body are engaged with the attachment points of the breaker housing, and wherein the escutcheon body includes a clearance area configured to allow a switch of the circuit breaker to be accessible and functional with the escutcheon body engaged to the breaker housing.

13. The system as recited in claim 10, wherein the escutcheon body includes a test or reset button configured to mechanically interface with a test or reset mechanism of the mechanical switch; and/or wherein the escutcheon body includes a service LED.

14. The system as recited in claim 10, further comprising a printed circuit board assembly (PCBA) assembled in the breaker housing, wherein the PCBA includes an electrical interface operatively connected to circuit components of the escutcheon module.

15. The system as recited in claim 14, wherein the PCBA includes circuitry configured to connect an external device to interact with the circuit breaker, wherein the PCBA includes an input/output interface configured for connecting with the external device by at least one of:
a USB connection;
a Bluetooth connection; or
a Wi-Fi connection.

16. The system as recited in claim 10, wherein the escutcheon body includes a display configured to connect to circuitry of the circuit breaker to display information regarding the circuit breaker with the escutcheon module engaged to the circuit breaker.

17. The system as recited in claim 16, wherein the display includes a touch screen for user interaction with the circuit breaker.

18. The system as recited in claim 10, wherein the escutcheon body includes at least one receptacle for a physical lock positioned to lock the mechanical switch.

19. The system as recited in claim 10, wherein the circuit breaker is a miniature circuit breaker (MCB).

20. The system as recited in claim 19, wherein the circuit breaker is configured for at least one of single phase, single pole (1P), single phase double pole (2P), single phase three pole (3P), ground fault (GF), arc fault (AF), and/or combined ground fault and arc fault (DF) operation.
